(19) United States
(12) Patent Application Publication
(10) Pub. No.: US 2023/0411920 A1
(43) Pub. Date: Dec. 21, 2023

(54) DEVICE AND METHOD FOR ASSEMBLING A PLUG CONNECTOR

(71) Applicant: Metzner Holding GmbH, Ulm (DE)

(72) Inventors: Manfred SORG, Ulm (DE); Pascal MAIER, Ulm (DE)

(21) Appl. No.: 18/032,579

(22) PCT Filed: Oct. 28, 2021
(86) PCT No.: PCT/EP2021/080015

§ 371 Date: Apr. 19, 2023

(30) Foreign Application Priority Data
Oct. 29, 2020 (DE) 10 2020 128 437.3

(51) Int. Cl. H01R 43/28; H01R 43/052; H01R 43/05; H02G 1/12

(52) U.S. Cl. CPC H01R 43/28; H01R 43/052; H01R 2103/00; H02G 1/1256; H01R 43/05

(57) ABSTRACT

The invention relates to a device (1) for assembling a plug connector (2) on a front end portion of at least one first cable (3.1). The device (1) has a first holding element (13) for holding the first cable (3.1) at a holding portion. The holding portion is arranged downstream of the front end portion along the longitudinal axis (L) of the first cable (3.1) in the direction of a rear cable end. The first holding element (13) is designed to pivot about the front end portion of the first cable (3.1).

The present application claims the priority of the German patent application No. 10 2020 128 437.3, the contents thereof being fully incorporated herein by way of reference.

The invention relates to a device for assembling a plug connector or a plug connector component on a front end portion of at least one line, having a holding element for holding the line on a holding portion according to the preamble of claim 1.

The invention further relates to a method for assembling a plug connector or a plug connector component on a front end portion of at least one line, according to which a holding element holds the line on a holding portion according to the preamble of claim 29.

The invention further relates to a computer program product with program code means in order to carry out a method for assembling a plug connector.

For assembling a plug connector on a line, in particular a cable end of a cable, it can be provided to orientate and/or to position the line, to cut the line to length, to prepare, for example to strip, individual line components for assembling plug connector components, to connect the plug connector components to line components and/or to push, for example, initially the cable sheath of a cable or an insulator of a conductor loosely onto the line for subsequent use, and to connect together the plug connector components, in particular during the course of the final assembly of the plug connector.

Insofar as reference is made within the scope of the invention to assembling the plug connector, this can be understood to mean an individual method step or a plurality of method steps, including all method steps, which can generally be provided when assembling a plug connector on a line.

A plug connector can be a plug, a built-in plug, a bushing, a coupling or an adapter. The term “plug connector” which is used within the scope of the invention is representative of all variants.

In particular, high requirements are set for plug connectors for the automobile industry or for vehicles, for the robustness thereof and for the safety of the plug connections. Primarily, electromobility poses great challenges for the automobile industry and the suppliers thereof, since high currents with voltages of up to 1500 V are sometimes transmitted in the vehicles via the cables and lines. In view of the danger which might result from a malfunction of components in an electric vehicle, accordingly particularly high requirements have to be set for the quality of the cables or lines and plug connections.

Thus a plug connection sometimes has to withstand high loads, for example mechanical loads, and remain closed in a defined manner so that the electrical connection is not inadvertently disconnected, for example during the operation of a vehicle.

A further requirement for plug connectors for the automobile industry is that they have to be able to be produced economically in large quantities. For this reason a plug connector assembly which is as fully automated as possible is preferred, in particular for producing prefabricated cables or lines for the automobile industry. Thus corresponding assembly lines have to be established in order to achieve the required quantities while at the same time maintaining high quality.

In particular, if a line is to be provided with a plug connector at one of its ends or at both of its ends, it is generally necessary to push various plug connector components onto the line in the subsequently required sequence, in order to keep these plug connector components ready for the plug connector assembly. The plug connector components, which have been previously pushed on, can then be moved one after the other or at the same time on the sheath of the line in the direction of the front free end of the line, for example in order to be joined to a corresponding plug connector component. In particular, the transport of the pre-fitted line is complex in the context of an automatic plug connector assembly.

Depending on the respective plug connector type, it can be provided to connect a single line or a plurality of lines to the plug connector. Thus, in particular, a common plug connector can be provided for a plurality of lines, for example for two lines. The lines are generally inserted parallel or adjacent to one another in the common plug connector and have the same length or at least approximately the same length. Due to the lines running closely adjacent to one another, the individual line processing (also sometimes denoted as “pre-fabrication”) is exceptionally difficult, in particular in the context of an automated or semi-automated assembly. The ability to process the individual lines, for example for a stripping or crimping process, is not readily ensured since the adjacent line can make access difficult.

In view of the known prior art, the object of the present invention is to provide a device for assembling a plug connector on a front end portion of a line, which is advantageously suitable, in particular, in the context of an automated or semi-automated plug connector assembly.

The object of the present invention is also to provide a method for assembling a plug connector on a front end portion of a line, which is advantageously suitable, in particular, in the context of an automated or semi-automated plug connector assembly.

Finally, it is also the object of the invention to provide a suitable computer program product for assembling an electrical plug connector.

The object is achieved for the device by the features set forth in claim 1. Regarding the method, the object is achieved by the features of claim 29. Relative to the computer program product, the object is achieved by the features of claim 33.

The dependent claims and the features described hereinafter relate to advantageous embodiments and variants of the invention.

A device for assembling a plug connector (or at least a plug connector component) on a front end portion of at least one line is provided.

It can be provided within the scope of the invention to assemble the plug connector on exactly one single line. Preferably, however, it is provided to assemble the plug connector on a plurality of lines, preferably on exactly two lines, but also for example on exactly three lines, exactly four lines, exactly five lines, exactly six lines or even more lines. One of the aforementioned lines is denoted hereinafter as the “first line” and another of the lines as the “second line”.

The respective lines can be processed one after the other or at the same time during the course of the plug connector assembly. Preferably, however, the lines are processed one after the other, particularly preferably by the same processing tools and/or processing modules.

If reference is made hereinafter to “the” line or “a” line (or the “first” or “second” line) this is not to be understood as limiting, but is merely intended to serve for improved readability. In principle, all of the developments and variants of the invention described hereinafter can relate to exactly one line, exactly two lines, or even more lines, even when this is not explicitly specified. In particular, the features and variants which relate to the first line can also relate to the second line and vice versa.

Preferably, the line is configured as an electrical line, in particular as an electrical cable or as an electrical conductor (for example an internal conductor of an electrical cable). The line, however, can also be configured as an optical line or as an optical/electrical hybrid line. Quite particularly preferably, the line is configured as a high-voltage cable.

Hereinafter, the invention is described substantially for use with a line configured as an electrical cable—but this is not to be understood as limiting.

Preferably, the plug connector is configured as an electrical plug connector. The plug connector, however, can be configured, for example, as an optical plug connector or as an optical/electrical plug connector. Quite particularly preferably, the plug connector is configured as a high-voltage plug connector.

Within the scope of the invention, the line and/or the plug connector can be considered as part of the device. The line and/or the plug connector can optionally also be independent of the device.

In particular, within the scope of the invention any electrical cable can be assembled in any electrical plug connector. Preferably, the electrical cable has exactly one external conductor or is configured as a shielded electrical cable. Particularly advantageously, the invention is suitable for processing electrical cables of large cross section for a high current transmission, for example in the vehicle sector, particular preferably in the field of electromobility. Thus an electrical cable can be provided for high-voltage applications, in particular a high-voltage line.

The electrical cable can have any number of internal conductors, but preferably only a single internal conductor. However, two internal conductors or more internal conductors, three internal conductors or more internal conductors, four internal conductors or even more internal conductors can also be provided.

Particularly preferably, the electrical cable is configured as a coaxial cable with exactly one internal conductor and exactly one external conductor.

In particular, the invention can be provided for an automated or fully automated assembly of the electrical plug connector.

The device has at least one first holding element for holding the first line on a holding portion.

Preferably, the device has exactly one holding element per line, such as for example the second holding element which is also mentioned hereinafter for holding the second line.

If reference is made hereinafter to “the” holding element or “a” holding element (or the “first” or “second” holding element) this is not to be understood as limiting but is merely intended to serve for improved readability. In particular, features and variants which refer to the first holding element can also refer to the second holding element and vice versa.

The aforementioned holding portion of the line is arranged downstream of the front end portion along the longitudinal axis of the line in the direction of a rear line end.

The holding portion is thus spaced apart from the front line end, and preferably is located outside the processing region of the front end portion of the line.

According to the invention, the first holding element is configured to pivot the front end portion of the first line.

Advantageously, the holding element can be used to pivot the front end portion of the line in order to improve the accessibility for processing in the course of the assembly of the plug connector, or even to permit this in the first place. For example, as a result, the front end portion of the line can be made easily accessible for a stripping tool or for a crimping tool for crimping a contact element to the line.

In particular, within the scope of the invention the front end portion of an electrical cable or the front end portion of an electrical conductor, for example an internal conductor of an electrical cable, can be pivoted.

If the invention is provided for assembling a plug connector on exactly one line, the front end portion of the line can be advanced to a processing tool or to a processing module by pivoting. Thus it can also be provided, for example, that different processing tools or processing modules (for example two, three, four or even more processing tools or processing modules) are located at different angular positions along the pivoting range. The line can then be advanced successively to the different processing modules or processing tools by the pivoting movement.

The invention is particularly advantageous, however, when a plurality of lines are assembled in a common plug connector or a common plug connector component. In this case, the accessibility of the individual lines can be significantly improved for the processing, or even made possible in the first place, by the pivoting of the lines, for example by one of the lines being pivoted away from the other line or the other lines.

In a particularly preferred development of the invention, it can be provided that the device has a second holding element for holding a second line on a holding portion which is arranged downstream of the front end portion along the longitudinal axis of the second line in the direction of a rear line end.

The second holding element can preferably be configured to pivot the front end portion of the second line.

Thus it can be provided, for example, to pivot alternately exactly one of the two lines while the other line is not pivoted. As a result, the accessibility of the pivoted line and the non-pivoted line can be improved. Optionally, both lines can also be pivoted (in opposing directions) in order to increase further the spacing between the lines.

In this manner, an advantageous cable processing can take place sequentially by the same processing tools or processing modules. However, it is also possible to process a plurality of lines at the same time.

The device can also have further holding elements for holding further lines on a corresponding holding portion which optionally can also be configured to be pivotable. For example, it is possible to provide a third holding element for holding a third line, a fourth holding element for holding a fourth line, a fifth holding element for holding a fifth line, a sixth holding element for holding a sixth line, or even more holding elements and lines.

For simplification, the invention is described hereinafter substantially by the use of exactly two lines and exactly two holding elements. This is a preferred exemplary embodiment which, however, is not to be understood as limiting.

In an advantageous development of the invention it can be provided that the first holding element and/or the second holding element have one respective line receiver which is configured to fix the corresponding line positively and/or non-positively to a sheath.

For example, a U-shaped line receiver can be provided, optionally a U-shaped line receiver with at least one undercut or at least one projection in the region of the upper, free ends of the limbs in order to permit the line to be snapped in when it is pushed into the line receiver. The limbs of the U-shaped line receiver can be correspondingly configured to be resilient.

Alternatively, for example, it is also possible to provide a line receiver with two clamping jaws, or a different line receiver.

According to a development of the invention, it can be provided that the first holding element and/or the second holding element can be advanced onto the line for receiving the line and can be moved away from the line for releasing the line.

Preferably, the holding elements can be advanced at right angles to the longitudinal axis of the line.

It can also be provided that the line can be advanced in the direction of the respective holding element (alternatively or additionally to the ability to advance the respective holding element).

According to one development, it can be provided that the line receiver is fastened to a first end of at least one guide pin which can be displaced (preferably at right angles) relative to the longitudinal axis of the line.

For improved stability, a plurality of guide pins can be provided per line receiver, for example exactly two guide pins.

A guide pin can have a round, rectangular or other cross section.

Instead of a guide pin or in addition to a guide pin, the line receiver can also be fastened to a first end of a guide projection which can be displaced relative to the longitudinal axis of the line (preferably at right angles).

In one development, it can be provided that the guide pin (or the guide projection) extends through a recess of a support surface and can be displaced in a linear manner in the recess.

Preferably, the recess is configured as a through-bore and extends entirely through the component defining the support surface. However, a blind bore can also be provided.

In one development, it can be provided that a compression spring (preferably circulating around the guide pin) is arranged between the support surface and the line receiver in order to advance the line receiver onto the line in an uninfluenced basic state for receiving the line, wherein the line receiver can be displaced together with the guide pin counter to the spring force of the compression spring for releasing the line.

In order to remove the line receiver from the line, for example, a plunger of an actuator can be pushed counter to the line receiver (alternatively the actuator can also pull on the line receiver) in order to deflect the line receiver counter to the spring force of the compression spring. The actuator can be, for example, an electrically, pneumatically or hydraulically driven actuator. If the line receiver is uninfluenced by the actuator, the restoring force of the compression spring can lead to the line receiver being returned to its holding position for the line.

A reverse design is also naturally possible, according to which a tension spring is arranged between the support surface and the line receiver in order to remove the line receiver from the line in an uninfluenced basic state for releasing the line.

In an advantageous development of the invention, it can be provided that the first holding element and/or the second holding element are configured to pivot the front end portion in an angular range of between 0° (non-pivoted state) and 120°, preferably in an angular range of between 20° and 100°, particularly preferably in an angular range of between 45° and 90°.

Optionally, a specific pivot angle can be predeterminable within the angular range. Accordingly, the pivoting does not necessarily have to take place exclusively between a non-pivoted state and a fully pivoted state.

For example, it can also be provided that the respective holding element advances the line successively to different pivot angle positions, in order for example to reach different processing tools or processing modules.

In one development of the invention, it can be provided that the first holding element and the second holding element are configured to pivot the front end portions in opposing directions.

In particular, the pivoting of the lines in opposing directions (which does not necessarily have to take place at the same time) can be advantageous in order to utilize a potentially restricted processing station within the device in a particularly effective manner.

In an advantageous development of the invention, it can be provided that the first holding element and/or the second holding element are rotatably mounted about one respective pivot axis.

Preferably, the pivot axis is arranged eccentrically or offset to a central axis of the line receiver of the respective holding element.

In an advantageous development of the invention, it can be provided that the first holding element and/or the second holding element are fastened in the region of a first end of one respective extension arm, wherein the extension arm is rotatably mounted about the pivot axis in the region of a second end.

Preferably, the extension arm can define the support surface in which the recess for the guide pin of the respective holding element is configured.

In an advantageous development, it can be provided that the extension arm has an actuating pin which is configured to pivot the extension arm and thus the respective holding element about the pivot axis.

The actuating pin is preferably guided through a support plate. The support plate can directly adjoin the extension arm or the extension arm can be arranged on the support plate and guided by the support plate.

According to a first variant, the actuating pin can be arranged coaxially to the pivot axis. The actuating pin can thus be actuated or rotated, for example, from the lower face of the support plate in order to pivot the extension arm on the support plate.

According to a preferred second variant, however, the actuating pin can also be arranged axially offset to the pivot axis. The actuating pin in this case is preferably received in a sliding guide, the actuating pin being forcibly guided thereby at least along an angular portion about the pivot axis. The sliding guide can be configured, in particular, as a recess in the support plate in which the actuating pin is guided in the manner of a sliding block. Preferably, the sliding guide describes a circular path or circular arc around the pivot axis, wherein the central point of the circular arc is preferably arranged on the pivot axis.

Further arrangements for the actuating pin can also be provided. The aforementioned two variants are not to be understood as definitive.

In one development of the invention, it can be provided that the device has at least one actuator unit which is configured to pivot the first holding element and/or the second holding element (in particular, the respective line receiver thereof), preferably by means of the actuating pin of the extension arm.

The actuator unit can preferably be configured as an electric motor, pneumatic motor or hydraulic motor.

In one development, it can be provided that the actuator unit is configured to introduce a rotational movement into the actuating pin which is arranged coaxially to the pivot axis.

Preferably, the coaxially arranged actuating pin has a rectangular or other non-circular cross section. The actuator unit can then particularly advantageously introduce a rotation via the actuating pin.

In one development, it can also be provided that the actuator unit is configured to displace the actuating pin, which is arranged axially offset to the pivot axis, in a linear manner in order to move the actuating pin inside the sliding guide.

Preferably, the actuating pin, which is arranged axially offset, has a round cross section in order to permit a guidance inside the sliding guide with particularly low friction.

Preferably, the actuator unit has a transport slide which it is configured to receive temporarily the actuating pin for the displacement of the actuating pin.

The actuating pin can optionally have one or more rollers on its axial portion guided in the sliding guide and/or in the transport slide in order to permit a displacement with particularly low friction.

In one development of the invention, it can be provided that the device has a fixing unit for fixing the at least one line to a fixing portion. The fixing portion is preferably arranged downstream of the holding portion along the longitudinal axis of the line in the direction of the rear line end.

Preferably, the fixing unit can be configured to fix all of the lines at the same time. However, in principle, the fixing unit can also be configured to fix one respective line individually.

The fixing unit can be actuatable manually and/or automatically.

The fixing unit can be configured purely mechanically.

In a preferred development of the invention, however, it can be provided that the fixing unit is configured as a pneumatic fixing unit, wherein the fixing unit fixes the line(s) in a state without the application of compressed air and releases the line(s) in a state with the application of compressed air. In this manner, in particular, an automatic line fixing can be provided.

Preferably, the fixing unit is configured to release the line(s) exclusively at defined processing stations for introducing and removing the lines. In this manner, it can be ensured that production personnel do not remove a line from the device during the processing. This can be advantageous, in particular, for reasons of process safety, ease of use and/or handling safety.

In an advantageous development, it is possible to provide a compressed air coupling unit which is configured to supply compressed air to the fixing unit exclusively at processing stations for introducing and removing the lines.

In one development, the compressed air coupling unit can have at least one pivot arm which is designed to introduce a first compressed air connector, which is arranged on the pivot arm, into a corresponding second compressed air connector, which is pneumatically connected to the fixing unit.

Preferably, exactly two pivot arms are provided in order to introduce two first compressed air connectors from opposing sides into a common second compressed air connector.

Preferably, the first compressed air connector or the second compressed air connector has a collecting funnel and the respective other compressed air connector has a cone in order to simplify the joining of the compressed air connectors.

In one development of the invention, it can also be provided that the device has at least one stop element which is arranged along the at least one line at a stop position assigned to the stop element in order to block positively the displacement path of plug connector components on the line. Preferably, the stop position is arranged downstream of the holding portion along the longitudinal axis of the at least one line in the direction of the rear line end.

The stop elements can be configured, in particular, as pins or projections on the line carrier to be described in more detail hereinafter.

The stop elements can be flexibly positionable manually or mechanically/automatically, in order to adopt different axial positions as required. The stop elements can be positionable freely or in a predetermined grid pattern.

The stop elements can be positioned equidistant from one another.

The plug connector components can be any components of the plug connector to be assembled, which preferably have a through-bore for receiving one or more lines. The plug connector components can thus be pushed onto the line(s), in particular onto a sheath of the line(s). The diameter of the through-bores can substantially correspond to the diameter of the line or the sheath thereof. The diameter of the through-bore, however, can also be larger or slightly smaller than the diameter of the line or the sheath thereof in order to be able to influence the mechanical play of a plug connector component pushed onto the line.

In principle, the line can be fitted with any plug connector components, for example with a shielding sleeve, a plug connector housing, a contact part carrier, a contact element, a compression sleeve (for example a crimp sleeve), a line seal, a cable retaining device, a retaining cap or an angled cap.

The line can be fitted with the plug connector components manually, for example by production personnel, or mechanically/automatically.

In some cases, the plug connector components can be loosely or axially displaceable on the line until they are joined with other plug connector components during the course of assembling the plug connector, and finally fastened to the line. After fitting the plug connector components, in order to avoid that the plug connector components are displaced in an uncontrolled manner during further processing and/or during transport (for example being pushed too close together for the subsequent processing or even sliding into one another) or even dropping off the line, the stop elements can be advantageous for securing the axial positions of the plug connector components.

Stop elements can also be provided, and due to their arrangement, for example laterally directly adjacent to the plug connector components, the stop elements can prevent a twisting of the plug connector components on the line or an inadvertently incorrect assembly of the plug connector components on the line.

In one development, it can be provided that the at least one stop element is arranged between the first line and the second line.

The stop elements arranged between the first line and the second line can be configured, for example, as a pin or projection.

However, the stop elements can also be positioned, for example, laterally adjacent to the respective line or the lines. For example, in each case two stop elements which are arranged at the same axial position can form a stop element pair, the at least one line running therebetween.

It is possible to be able to advance the stop elements in the direction of the longitudinal axis of the cable manually or mechanically/automatically. The stop elements can be displaceable, for example, along one respective guide rail in the direction of the longitudinal axis of the cable or guided through corresponding bores in the line carrier, also mentioned hereinafter.

According to one development, it can be provided that at least one of the stop elements is mechanically coupled to an actuating element in order to move the at least one stop element out of the displacement path of the plug connector components by actuating the actuating element.

The actuation of the actuating element can take place manually, for example by production personnel, or mechanically/automatically.

The stop elements can be actuatable individually, for example by one respective actuating element, or even actuatable in combination, for example by an actuating element coupled to a plurality of stop elements or all of the stop elements.

In an advantageous embodiment, it is possible to provide latching bolts which are configured to block one of the actuating elements or to block a plurality of the actuating elements in their actuated state. In this case, the line can be fitted with the plug connector components in a particularly user-friendly manner.

In one development of the invention, it can be provided that the device has a transport apparatus. The transport apparatus preferably comprises a workpiece carrier for the transport of the at least one line between individual processing modules and/or processing tools (of the device or a higher-order system) in a line transport direction.

The transport apparatus can be configured, for example, as an assembly line system or linear actuator, in order to move one or more workpiece carriers together or individually in the line transport direction. A gripper apparatus can also be provided for the transport of the workpiece carrier and, in particular, also a combination of different transport methods.

Different processing steps in the context of the plug connector assembly can be optionally distributed to a plurality of processing modules in order to operate the device as an “assembly line process” or as a “clocked automated process” with successive individual steps, in order to reduce the processing time in the case of mass production.

In this case, the transport apparatus can transport the lines in a correspondingly clocked manner between the processing modules.

In an advantageous development of the invention, it can be provided that a line carrier (preferably a cable carrier) is fastened to the workpiece carrier, with the first holding element, the second holding element, the fixing unit and/or the stop elements being arranged thereon.

The line carrier can be assembled fixedly or immovably on the workpiece carrier. In this case, it can be provided to advance the processing tools and/or processing modules at right angles or at least substantially at right angles to the line transport direction onto the front end portion of the respective line for the processing. However, the pivoting movement of the holding elements can also be provided for the advancing movement.

In an advantageous development of the invention, it can also be provided alternatively or additionally that the line carrier is movable on the workpiece carrier in an advancing direction in order to advance the front end portion of the at least one line onto at least one processing tool and/or one processing module for the processing.

However, exclusively advancing the processing tools or processing modules is preferred.

In one embodiment of the invention, it can be provided that the line carrier, the lines, the workpiece carrier, the processing modules and/or the processing tools have an information carrier, for example an RFID transponder, a barcode, a QR code or a different marking in order to identify the line carrier, the line, the workpiece carrier, the processing modules and/or the processing tools, to detect a correct position and/or to document the processing in a trackable manner. Accordingly, writing/reading devices can be provided inside the device in order to read and/or write to the information carrier.

According to one development of the invention, it can be provided that the transport apparatus has a guide groove for guiding the actuating pin of the first holding element and/or the second holding element. Alternatively or additionally, it can be provided that the transport apparatus has a guide groove for guiding a separate transport pin of the extension arm of the first holding element and/or the second holding element.

Preferably, one of the actuator units is arranged in at least one position along the guide groove for pivoting the extension arm.

The invention further relates to a method for assembling a plug connector (or a plug connector component) on a front end portion of at least one first line, according to which a first holding element holds the first line on a holding portion which is arranged downstream of the front end portion along the longitudinal axis of the first line in the direction of a rear line end. It is provided that the first holding element pivots the front end portion of the first line, as required.

The plug connector assembly can be automated particularly flexibly and in particular particularly easily by pivoting the front end portion of the line through the holding element, as required.

In an advantageous development of the invention, it can be provided in particular that a second holding element holds a second line on a holding portion which is arranged downstream of the front end portion along the longitudinal axis of the second line in the direction of a rear line end, wherein the second holding element pivots the front end portion of the second line, as required.

Preferably, selectively the first holding element pivots the first line or the second holding element pivots the second line. In principle, it is also possible to pivot both lines at the same time, but this is not necessarily preferred.

In an advantageous development of the invention, it can be provided in particular that the first holding element holds the front end portion of the first line in a pivoted state, while the front end portion of the second line is processed for assembling the plug connector (preferably in a non-pivoted state).

Accordingly, it can also be provided that the second holding element holds the front end portion of the second line in a pivoted state, while the front end portion of the first line is processed for assembling the plug connector (preferably in a non-pivoted state).

In one development of the invention, it can be provided in particular that the first holding element holds the front end portion of the first line in a non-pivoted state, while the front end portion of the first line is processed for assembling the plug connector.

It can also be provided that the second holding element holds the front end portion of the second line in a non-pivoted state, while the front end portion of the second line is processed for assembling the plug connector.

The invention further relates to a computer program product with program code means, in order to carry out a method according to the embodiments above and below when the program is executed on a control apparatus of a device for assembling a plug connector (in particular on a device according to the embodiments above and below).

The control apparatus can be configured as a microprocessor. Instead of a microprocessor, any other apparatus can be provided for implementing the control apparatus, for example one or more arrangements of discrete electrical components on a printed circuit board, a memory programmable controller (MPC), an application-specific integrated circuit (ASIC) or any other programmable circuit, for example a field programmable gate array (FPGA), a programmable logic array (PLA) and/or a commercial computer.

Features which have been described in connection with one of the subjects of the invention, namely provided by the device according to the invention, the method according to the invention and the computer program product, are also able to be advantageously implemented for the other subjects of the invention. Advantages which have been mentioned in connection with one of the subjects of the invention can also be understood to refer to the other subjects of the invention.

In addition, it should be mentioned that the terms such as “comprising”, “having” or “with” do not exclude any other features or steps. Moreover, terms such as “a” or “the” which refer to a number of steps or features do not exclude a plurality of features or steps and vice versa.

In a purist embodiment of the invention, however, it can also be provided that the features introduced into the invention by the terms “comprising”, “having” or “with” are a definitive list. Accordingly, one or more lists of features can be considered as definitive within the scope of the invention, for example considered in each case for each claim. The invention can exclusively consist of the features mentioned in claim 1, for example.

It should be mentioned that the terms such as “first” or “second” etc. are used primarily to differentiate between the respective device features or method features and are not necessarily intended to indicate that the features are mutually dependent or relate to one another.

It should also be emphasized that the values and parameters described in the present case include deviations or fluctuations of ±10% or less, preferably ±5% or less, further preferably ±1% or less and quite particularly preferably ±0.1% or less, from the respectively mentioned value or parameter, provided these deviations are not excluded when implementing the invention in practice. The specification of ranges by initial values and final values also encompasses all of those values and fractions which are included by the respectively mentioned range, in particular the initial values and final values and a respective mean value.

The invention further relates to a device, independent of claim 1, for assembling a plug connector on a front end portion of at least one line, having at least one stop element which is arranged along the at least one line at a stop position assigned to the stop element in order to block positively the displacement path of plug connector components on the line. The further features of claim 1 and the dependent claims and the features described in the present description relate to advantageous embodiments and variants of this device. Exemplary embodiments of the invention are described in more detail hereinafter with reference to the drawing.

The figures show in each case preferred exemplary embodiments in which individual features of the present invention are shown in combination with one another. Features of one exemplary embodiment are also able to be implemented separately from the other features of the same exemplary embodiment, and accordingly can be readily combined by a person skilled in the art to form further meaningful combinations and sub-combinations with features of other exemplary embodiments.

Elements which are functionally the same are provided with the same reference signs in the figures.

In the figures, schematically:

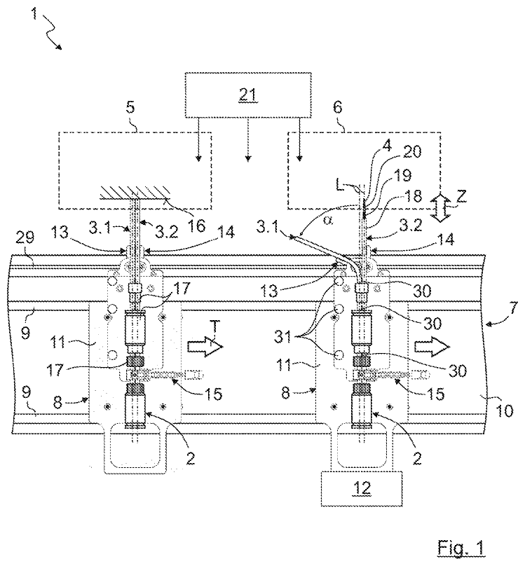

FIG. 1 shows a device according to the invention for assembling a plug connector on a front end portion of a first electrical cable and a second electrical cable in a plan view;

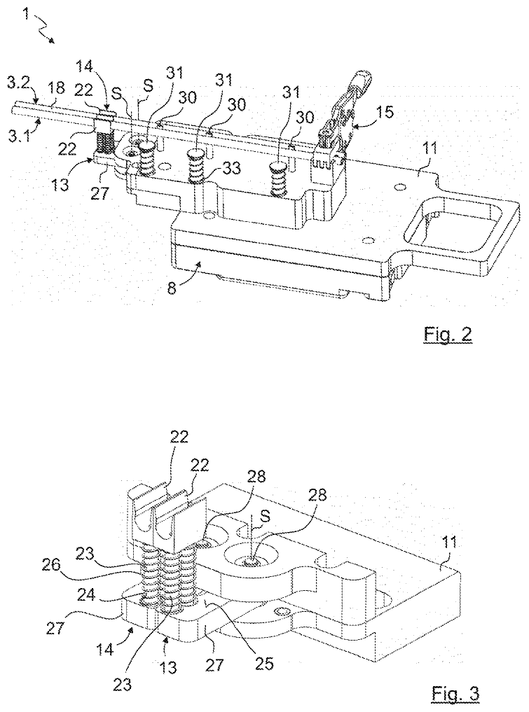

FIG. 2 shows a workpiece carrier and a line carrier of the device according to the invention of FIG. 1 in a perspective view;

FIG. 3 shows the holding elements of the device according to the invention of FIG. 1 in a perspective individual view in an uninfluenced state;

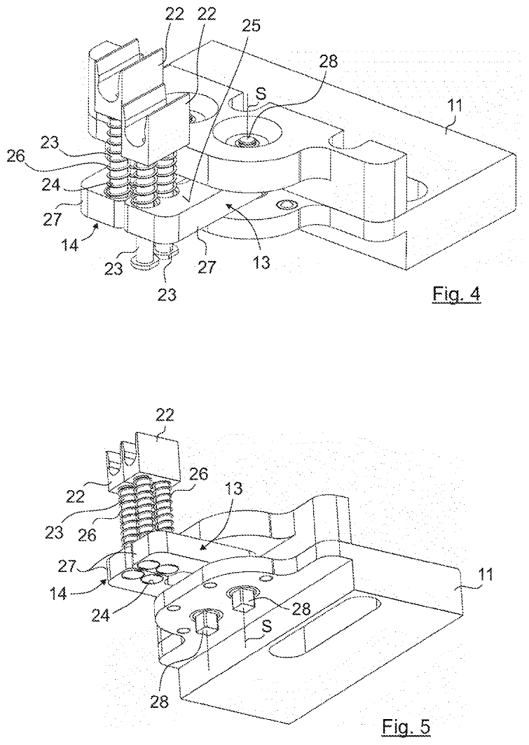

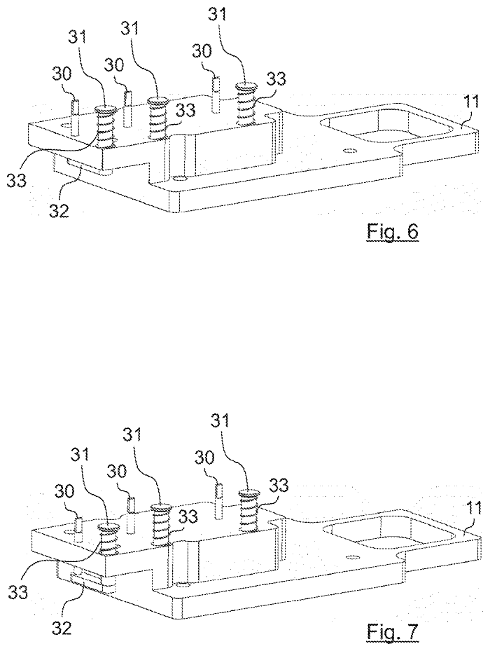

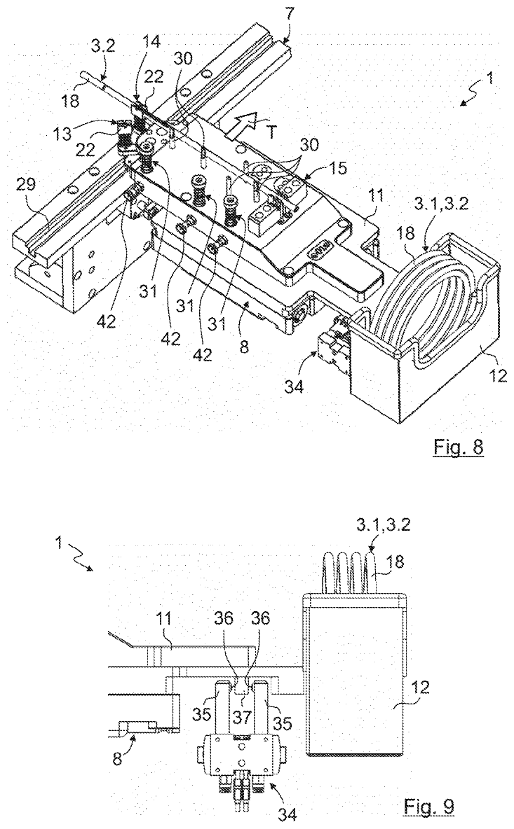

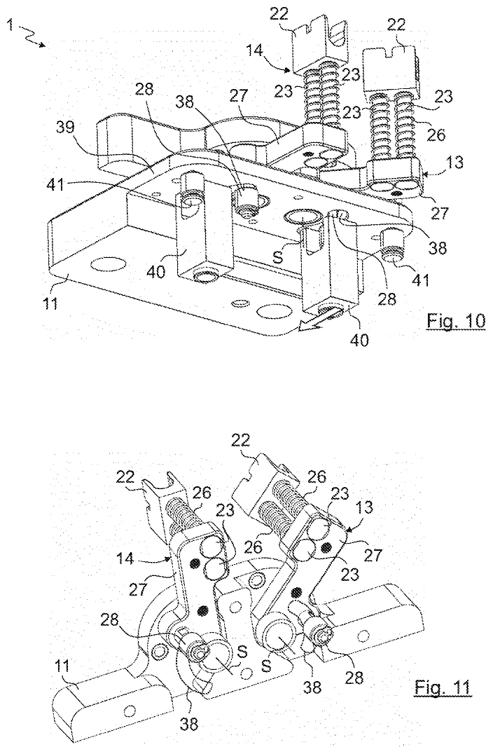

FIG. 4 shows the holding elements according to FIG. 3, wherein one of the holding elements is shown by way of example in a deflected state;

FIG. 5 shows the holding elements according to FIG. 3 in a further perspective view;

FIG. 6 shows a perspective individual view of the line carrier of the device according to the invention of FIG. 1 with the stop elements;

FIG. 7 shows the individual view according to FIG. 6 with a deflected stop element by way of example;

FIG. 8 shows a detail of a device according to the invention according to a preferred embodiment in a perspective view;

FIG. 9 shows the compressed air coupling unit of the device according to FIG. 8 in a side view;

FIG. 10 shows the holding elements of the device of FIG. 8 in a perspective individual view; and

FIG. 11 shows the holding elements of FIG. 10 in an even more detailed individual view.

FIG. 1 shows a device for assembling a plug connector 2 on at least one line 3.1, 3.2 according to an exemplary embodiment of the invention.

Merely by way of example, the device 1 is described for use with two lines which are configured as electrical cables 3.1, 3.2. However, in principle, a line can be any line, for example an internal conductor 4 of a cable 3.1, 3.2, an optical cable or an optical fiber. Moreover, the invention can also be advantageously suitable for use with only a single line or for use with more than two lines.

The electrical plug connector 2 shown is also understood to be merely by way of example.

Within the scope of the invention, it can optionally be provided to attach a plug connector 2 to both ends of the at least one line 3.1, 3.2 (potentially also plug connectors of different construction). In the processing state of the cables 3.1, 3.2, shown in FIG. 1 for example, a fully assembled plug connector 2 is already shown on the rear line ends of the two cables 3.1, 3.2.

The device 1 can carry out any assembly steps in the course of assembling a plug connector. By way of example, two processing modules 5, 6 of the device 1 are shown in FIG. 1. The device 1, however, can also be part of a higher-order system for the plug connector assembly—accordingly the processing modules 5, 6 which are shown do not necessarily have to be assigned to the device 1.

For the transport of the cables 3.1, 3.2 between the individual processing modules 5, 6 or processing tools, a transport apparatus 7 can be provided, in particular a transport apparatus 7 with a workpiece carrier 8 (see in particular FIG. 2) which can be moved in a line transport direction T. In the exemplary embodiment, the workpiece carriers 8 are guided along two rails 9 of a linear actuator 10 and are preferably movable individually in, or counter to, the line transport direction T, for example by a magnetic drive. Purely by way of example, two workpiece carriers 8 are shown.

A line carrier 11 or cable carrier, on which the cables 3.1, 3.2 are held for transport and processing, can be fastened to the workpiece carrier 8. An individual workpiece carrier 8 with a line carrier 11 and several further components of the device 1 connected to the line carrier 11 are shown perspectively in an individual view in FIG. 2.

It can also be provided that the line carrier 11 is movable on the workpiece carrier 8 in an advancing direction Z, for example by using a rail system (not shown) in order to advance the cables 3.1, 3.2 onto at least one of the processing tools and/or onto at least one of the processing modules 5, 6 for the processing. Alternatively or additionally, however, the processing tools or the processing modules 5, 6 can also be advanced onto the cables 3.1, 3.2 as indicated in FIG. 1.

For simpler handling of longer cables 3.1, 3.2, the line carrier 11 can optionally have a cable receiver 12 in which the rear end portion of at least one of the cables 3.1, 3.2 can be received wound-up (in FIG. 1 indicated in dashed-dotted lines for the right-hand line carrier 11, see also FIGS. 8 and 9).

The device 1 has a first holding element 13 for holding a first cable 3.1 and a second holding element 14 for holding a second cable 3.2. The holding elements 13, 14 are fastened to the line carrier 11 and initially shown in FIGS. 3 to 5 in an individual view.

The holding elements 13, 14 hold the cables 3.1, 3.2 on a holding portion which is arranged downstream of the front end portion (on which the plug connector 2 is assembled) along the longitudinal axis L of the respective cable 3.1, 3.2 in the direction of the rear line end or cable end. As a result, it is possible to process the cables 3.1, 3.2 in a convenient manner in the portion upstream of the respective holding elements 13, 14.

For an advantageous fixing of the cables 3.1, 3.2 to the line carrier 11, a fixing unit 15 can also be provided on the line carrier 11 for fixing the at least one cable 3.1, 3.2 to a fixing portion. The fixing portion is preferably arranged downstream of the holding portion along the longitudinal axis L of the cable 3.1, 3.2 in the direction of the rear cable end. Preferably, the fixing unit 15 fixes all of the cables 3.1, 3.2 together. The fixing unit 15 can be actuatable manually and/or mechanically in order to fix or release the cables 3.1, 3.2 selectively. A manual fixing unit 15 is shown in the exemplary embodiment of FIGS. 1 to 7.

As already mentioned in FIG. 1 by way of example, two processing modules 5, 6 of the device 1 are shown.

A first processing module 5 can be configured, for example, for inserting the cables 3.1, 3.2 and, in particular, to this end have a stop 16 or a light barrier in order to assist production personnel, or an insertion apparatus when inserting the cables 3.1, 3.2. Individual plug connector components 17 can be already pushed onto the cables 3.1, 3.2 in advance. During the processing by the first processing module 5, the cables 3.1, 3.2 can be finally fixed on the line carrier 11 by the fixing unit 15 and introduced into the holding elements 13, 14.

The cables 3.1, 3.2 which are fastened to the line carrier 11 can then be transported by the transport apparatus 7 in the line transport direction T to a second processing module 6.

The second processing module 6 can be, for example, a stripping station in order to strip a cable sheath 18 of the cable 3.1, 3.2 in the region of the front end portion to a defined length, and/or to remove a cable foil (not shown) and/or to cut to length a cable shielding braid 19 and optionally to fold over and/or to strip a filling layer encasing a plurality of internal conductors 4 together (not shown) to a predefined length and/or in order to strip an insulator 20 of an internal conductor 4 to a predetermined length.

In principle, in the context of assembling the plug connector 2 any processing modules can be provided as part of the device 1 or an additional further device or a higher-order system.

So that the processing of an individual cable 3.1, 3.2 is advantageously possible and/or for advancing the front end portion of the cable 3.1, 3.2 to the processing modules 5, 6 and/or processing tools, the holding elements 13, 14 are configured to pivot the front end portion of the respective cable 3.1, 3.2.

In FIG. 1 a variant is shown by way of example in which the first holding element 13 holds the front end portion of the first cable 3.1 in a pivoted state, while the front end portion of the second cable 3.2 is processed (in this case stripped) for assembling the plug connector 2. After processing the first cable 3.1, the second cable 3.2 can be finally processed by the second holding element 14 pivoting the front end portion of the second cable 3.2, while the front end portion of the first cable 3.1 is held in a non-pivoted state by the first holding element 13.

Alternatively, it can also be provided that the respectively pivoted cable 3.1, 3.2 is processed while the non-pivoted cable 3.1, 3.2 is not processed. Moreover, both cables 3.1, 3.2 can be pivoted and optionally processed at the same time.

Preferably, the holding elements 13, 14 are configured to pivot the front end portions of the cables 3.1, 3.2 in opposing directions.

In particular, the holding elements 13, 14 can be configured to pivot the front end portion in an angular range of between 0° and 120°, preferably 20° to 100°, particularly preferably 45° to 90°. In particular, it can also be provided that the holding elements 13, 14 control a defined pivoting angle α.

For carrying out the proposed assembly method, a computer program product can be provided with program code means, wherein the program is executed on a control apparatus 21 of the device 1 (shown in FIG. 1 in dashed lines).

The holding elements 13, 14 are now to be described in further detail with reference to FIGS. 3 to 5.

The holding elements 13, 14 have one respective line receiver 22 which is configured to fix the corresponding line 3.1, 3.2 positively and/or non-positively on its sheath, in particular the cable sheath 18 or the insulator 20.

It is possible for the holding elements 13, 14 to be advanced onto the cable 3.1, 3.2 for receiving the cable 3.1, 3.2 and to be moved away from the cable 3.1, 3.2 for releasing the cable 3.1, 3.2. By way of example in FIG. 4, the line receiver 22 of the second holding element 14 is shown in a state advanced onto the second cable 3.2, and the line receiver 22 of the first holding element 13 is shown in a state spaced apart from the first cable 3.1.

The line receivers 22 are fastened to one respective first end of two guide pins 23 and are displaceable together with the guide pins 23 at right angles to the longitudinal axis L of the cable 3.1, 3.2. To this end, the guide pins 23 extend through recesses 24 in a support surface 25 and are displaceable in a linear manner in the respective recess 24.

One respective compression spring 26, circulating around the guide pin 23, is arranged between the support surface and the line receiver 22 in order to advance the line receiver 22 onto the cable 3.1, 3.2 in an uninfluenced basic state for receiving the cable 3.1, 3.2 (see the line receiver 22 of the second holding element 14 in FIG. 4), wherein the line receiver 22 is displaceable together with the guide pins 23 for releasing the cables 3.1, 3.2 counter to the spring force of the compression spring 26 (see the line receiver 22 of first holding element 13 in FIG. 4).

The holding elements 13, 14 are rotatably mounted about one respective pivot axis S. To this end, the holding elements 13, 14 are fastened in the region of a first end of one respective extension arm 27 which is rotatably mounted in the region of its second end about the pivot axis S.

The extension arm 27 is connected to an actuating pin 28 (see in particular FIG. 5) which runs coaxially to the pivot axis S and which is configured to pivot the extension arm 27 and thus the respective holding element 13, 14 about the pivot axis S. To this end, at least one actuator unit can be provided (not shown).

The actuating pins 28 of the extension arm 27 can preferably be guided in a guide groove 29 (see FIG. 1) of the transport apparatus 7. An actuator unit or a plurality of actuator units can be arranged at defined positions along the guide groove 29 for pivoting the extension arm 27.

As already explained above, it can be provided to push various plug connector components 17 onto the lines 3.1, 3.2, for example onto the cable sheath 18 of the respective cables 3.1, 3.2. The plug connector components 17 can be configured, in particular, in order to be pushed at the same time onto both cables 3.1, 3.2.

Stop elements 30 can be provided in order to hold the plug connector components 17 in a captive manner during the assembly of the plug connector 2 and preferably to hold the plug connector components at a defined position on the lines 3.1, 3.2 (see in particular FIGS. 2, 6 and 7). The stop elements 30 are arranged along the cables 3.1, 3.2 at respective stop positions in order to block the displacement path of the plug connector components 17 in a positive manner. The stop positions are arranged downstream of the holding portion along the longitudinal axis L of the cables 3.1, 3.2 in the direction of the rear line end or cable end.

Particularly preferably, the stop elements 30 are arranged between the two cables 3.1, 3.2, as can be clearly identified in FIG. 2. The stop elements 30 are preferably fastened to the line carrier 11.

In order to move the stop elements 30, if required, out of the displacement path of the plug connector components 17, for example in order to push the plug connector components 17 onto the cables 3.1, 3.2, or to make the stop elements available for the plug connector assembly, the stop elements 30 can be mechanically coupled, for example, to actuating elements 31. The principle is shown clearly in FIGS. 6 and 7. By way of example in FIG. 7, the front stop element 30 together with its actuating element 31 is actuated from its basic state, in which the stop element 30 blocks the displacement path of the plug connector component 17, in the direction of a release position.

The stop elements 30 are connected to the actuating elements 31 via one respective connecting web 32. So that the stop elements 30 are always located in the displacement path of the plug connector components 17, in a basic state without the application of force, corresponding compression spring elements 31 are arranged around the actuating elements 33.

A preferred exemplary embodiment of the invention is shown in FIGS. 8 to 11. The features of the second exemplary embodiment correspond largely to the features of the first exemplary embodiment, which is why the differences between the exemplary embodiments are substantially discussed hereinafter. The individual features and combinations of features can also be exchanged between the exemplary embodiments, provided this is not technically impossible.

The second exemplary embodiment, shown in FIGS. 8 to 11, of the device 1 according to the invention differs from the first exemplary embodiment, primarily in the design of the pivoting mechanism of the holding elements 13, 14 and the fixing unit 15.

The fixing unit 15 in the second exemplary embodiment is configured as pneumatic fixing unit 15 and thus can be particularly easily automated. The fixing unit 15 fixes the line 3.1, 3.2, preferably in a state without the application of compressed air, and releases it again for removal, in a state with the application of compressed air. To this end, a compressed air coupling unit 34 is provided (see in particular FIG. 9), the compressed air coupling unit being configured to supply compressed air to the fixing unit 15 preferably exclusively at processing stations for the dedicated introduction and removal of the lines, for example when the tool carrier 8 is located on the first processing module 5. The compressed air coupling unit 34 has two pivot arms 35 which are designed to introduce a first compressed air connector 36, which is arranged at the free end of the respective pivot arm 35, into a corresponding second compressed air connector 37 which is pneumatically connected to the fixing unit 15.

The pivoting mechanism of the second exemplary embodiment is to be described hereinafter with reference to FIGS. 10 and 11.

The holding elements 13, 14 are in turn rotatably mounted about one respective pivot axis S and to this end fastened in the region of a first end of one respective extension arm 27. The extension arm 27 has a round actuating pin 28 in order to pivot the extension arm 27 about the pivot axis S by means of the actuator unit. In contrast to the coaxial arrangement, however, the actuating pin 28 of the second exemplary embodiment is arranged axially offset to the pivot axis S and forcibly guided in a sliding guide 38 about the pivot axis S (only shown in dashed lines in FIG. 11). The sliding guide 38 is configured as a recess in a support plate 39 and describes a circular arc about the pivot axis S. The actuator unit, not shown in more detail, is configured to displace in a linear manner the actuating pin 28, which is arranged axially offset to the pivot axis S, (see arrow in FIG. 10) in order to move the actuating pin 28 inside the sliding guide 38. To this end, the actuator unit has corresponding transport slides 40 which for the displacement of the actuating pin 28 are brought into engagement therewith.

Separate transport pins 41, which are guided in the guide groove 29 of the transport apparatus 7, are provided for guiding the support plate 39 in the line transport direction T (see FIG. 1 and FIG. 8).

Optional latching bolts 42 are also shown in FIG. 8. The latching bolts 42 can be used in order to block one of the actuating elements 31 or a plurality of the actuating elements 31 in their actuated state. Fitting the line 3.1, 3.2 with the plug connector components 17 can be particularly user-friendly in this case.

For reasons of technical cleanliness it can be provided to cover any openings/bores etc. of the device 1, for example of the workpiece carrier 8 or the line carrier 11, for example for the openings/bores to be provided with cover caps or to be masked off.

What is claimed is:

1. A device for assembling a plug connector on a front end portion of at least one first line, having a first holding element for holding the first line on a holding portion which is arranged downstream of the front end portion along the longitudinal axis of the first line in the direction of a rear line end, wherein the first holding element is configured to pivot the front end portion of the first line, and a second holding element for holding a second line on a holding portion is arranged downstream of the front end portion along the longitudinal axis of the second line in the direction of a rear line end, wherein the second holding element is configured to pivot the front end portion of the second line, and wherein the first and second holding elements are configured to either pivot the first and second lines independently from each other or synchronously in opposing directions.

2. (canceled)

3. The device as claimed in claim 1, wherein the first holding element and/or the second holding element have one respective line receiver which is configured to fix the corresponding line positively and/or non-positively to a sheath.

4. The device as claimed in claim 1, wherein the first holding element and/or the second holding element can be advanced onto the line for receiving the line and can be moved away from the line for releasing the line (3.1, 3.2).

5. (canceled)

6. (canceled)

7. (canceled)

8. The device as claimed in claim 1, wherein the first holding element and/or the second holding element are configured to pivot the front end portion in an angular range of between 0° and 120°.

9. (canceled)

10. The device as claimed in claim 1, wherein the first holding element and/or the second holding element are rotatably mounted about one respective pivot axis.

11. The device as claimed in claim 10, wherein the first holding element and/or the second holding element are fastened in the region of a first end of one respective extension arm, and wherein the extension arm is rotatably mounted about the pivot axis in the region of a second end.

12. The device as claimed in claim 11, wherein the extension arm has an actuating pin which is configured to pivot the extension arm and thus the respective holding element about the pivot axis.

13. (canceled)

14. (canceled)

15. The device as claimed in claim 1, further comprising at least one actuator unit which is configured to pivot the first holding element and/or the second holding element by means of the actuating pin of the extension arm.

16. The device as claimed in claim 15, wherein the at least one actuator unit is configured to introduce a rotational movement into the actuating pin which is arranged coaxially to the pivot axis.

17. The device as claimed in claim 15, wherein the at least one actuator unit is configured to displace the actuating pin, which is arranged axially offset to the pivot axis, in a linear manner in order to move the actuating pin inside the sliding guide.

18. The device as claimed in claim 1, further comprising a fixing unit for fixing the at least one line to a fixing portion which is arranged downstream of the holding portion along the longitudinal axis of the line in the direction of the rear line end.

19. The device as claimed in claim 18, wherein the fixing unit is configured as a pneumatic fixing unit, wherein the fixing unit fixes the line in a state without the application of compressed air and releases the line(s) in a state with the application of compressed air.

20. The device as claimed in claim 19, further comprising a compressed air coupling unit (34) configured to supply compressed air to the fixing unit exclusively at processing stations for introducing and removing the lines.

21. (canceled)

22. The device as claimed in claim 1, further comprising at least one stop element arranged along the at least one line at a stop position assigned to the stop element in order to block positively the displacement path of the plug connector components on the line, wherein the stop position is arranged downstream of the holding portion along the longitudinal axis of the at least one line in the direction of the rear line end.

23. (canceled)

24. (canceled)

25. The device as claimed in claim 1, further comprising a transport apparatus including a workpiece carrier for the transport of the at least one line between individual processing modules and/or processing tools in a line transport direction.

26. The device as claimed in claim 25, wherein a line carrier is fastened to the workpiece carrier, with the first holding element, the second holding element, the fixing unit and/or the stop elements being arranged thereon.

27. The device as claimed in claim 26, wherein the line carrier is movable on the workpiece carrier in an advancing direction in order to advance the front end portion of the at least one line onto at least one processing module and/or processing tool for the processing.

28. (canceled)

29. A method for assembling a plug connector on a front end portion of at least one first line, according to which a first holding element holds the first line on a holding portion which is arranged downstream of the front end portion along the longitudinal axis of the first line in the direction of a rear line end, and the first holding element pivots the front end portion of the first line, as required, and a second holding element holds a second line on a holding portion which is arranged downstream of the front end portion along the longitudinal axis of the second line in the direction of a rear line end, wherein the second holding element pivots the front end portion of the second line, as required, and wherein the first and second holding elements either pivot the first and second lines independently from each other or synchronously in opposing directions.

30. (canceled)

31. The method as claimed in claim 30, wherein the first holding element holds the front end portion of the first line in a pivoted state, while the front end portion of the second line is processed for assembling the plug connector, and wherein the second holding element holds the front end portion of the second line in a pivoted state, while the front end portion of the first line is processed for assembling the plug connector.

32. (canceled)

33. A computer program product with program code means, in order to carry out a method as claimed in claim 29 when the program is executed on a control apparatus of a device for assembling a plug connector.
